(19) United States
(12) Patent Application Publication
(10) Pub. No.: US 2024/0364819 A1
(43) Pub. Date: Oct. 31, 2024

(54) DEVICE DIAGNOSIS SYSTEM THAT DECIDES WHETHER OPERATING SOUND OF IMAGE FORMING APPARATUS, COLLECTED BY PORTABLE TERMINAL DEVICE, CONTAINS ABNORMAL NOISE, AND DEVICE DIAGNOSIS METHOD

(71) Applicant: KYOCERA Document Solutions Inc., Osaka (JP)

(72) Inventors: Lin LU, Osaka (JP); Yuya OKAZAKI, Osaka (JP)

(73) Assignee: KYOCERA Document Solutions Inc., Osaka (JP)

(21) Appl. No.: 18/637,708

(22) Filed: Apr. 17, 2024

(30) Foreign Application Priority Data
Apr. 27, 2023 (JP) 2023-072905

(51) Int. Cl. H04N 1/00

(52) U.S. Cl. CPC H04N 1/00029; H04N 1/00061; H04N 2201/0001

(57) ABSTRACT

A device diagnosis system includes an image forming apparatus, a portable terminal device, and an abnormal noise decision device. The portable terminal device collects an operating sound of the image forming apparatus, at a sound collecting position selected from a plurality of predetermined sound collecting positions relative to the image forming apparatus. The abnormal noise decision device (a) identifies a decision criterion corresponding to the sound collecting position, and (b) decides whether the operating sound contains an abnormal noise, on a basis of acoustic data of the operating sound collected, in accordance with the decision criterion identified.

### INCORPORATION BY REFERENCE

This application claims priority to Japanese Patent Application No. 2023-072905 filed on Apr. 27, 2023, the entire contents of which are incorporated by reference herein.

### BACKGROUND

The present disclosure relates to a device diagnosis system and a device diagnosis method.

Some of existing image forming apparatuses are configured to store in advance an operating sound generated under normal operation, collect the operating sound of the current point, compare the operating sound of the current point with the operating sound in normal operation, thereby identifying the timing, at which the level difference between the operating sound of the current point and the operating sound in normal operation is equal to or larger than a predetermined threshold, as a timing of abnormal noise generation, and identify a malfunctioning part, on the basis of the operating sound collected at the identified timing of the abnormal noise generation.

### SUMMARY

The disclosure proposes further improvement of the foregoing techniques.

In an aspect, the disclosure provides a device diagnosis system including an image forming apparatus to be diagnosed, a portable terminal device, and an abnormal noise decision device. The portable terminal device collects an operating sound of the image forming apparatus, at a sound collecting position selected from a plurality of predetermined sound collecting positions relative to the image forming apparatus. The abnormal noise decision device includes a processor, and (a) identifies a decision criterion corresponding to the sound collecting position, and (b) decides whether the operating sound contains an abnormal noise, on a basis of acoustic data of the operating sound collected, in accordance with the decision criterion identified, when the processor executes a computer program.

In another aspect, the disclosure provides a device diagnosis method for an image forming apparatus, to be performed using a portable terminal device. The device diagnosis method includes a sound collecting process including collecting, with the portable terminal device, an operating sound of the image forming apparatus, at a sound collecting position selected from a plurality of predetermined sound collecting positions relative to the image forming apparatus, and a decision process including (a) identifying a decision criterion corresponding to the sound collecting position, and (b) deciding whether the operating sound contains an abnormal noise, on a basis of acoustic data of the operating sound collected, in accordance with the decision criterion identified.

The above and other objects, features, and advantages of the disclosure will become more apparent, through the detailed description given hereunder, with reference to the accompanying drawings.

### BRIEF DESCRIPTION OF THE DRAWINGS

FIG. 1 is a block diagram showing a configuration of a device diagnosis system according to a first embodiment of the disclosure;

FIG. 2 is a sequence chart for explaining an operation of the device diagnosis system according to the first embodiment;

FIG. 3 is a block diagram showing a configuration of a device diagnosis system according to a second embodiment of the disclosure; and

FIG. 4 is a sequence chart for explaining an operation of the device diagnosis system according to the second embodiment.

### DETAILED DESCRIPTION

Hereafter, some embodiments of the disclosure will be described, with reference to the drawings.

### First Embodiment

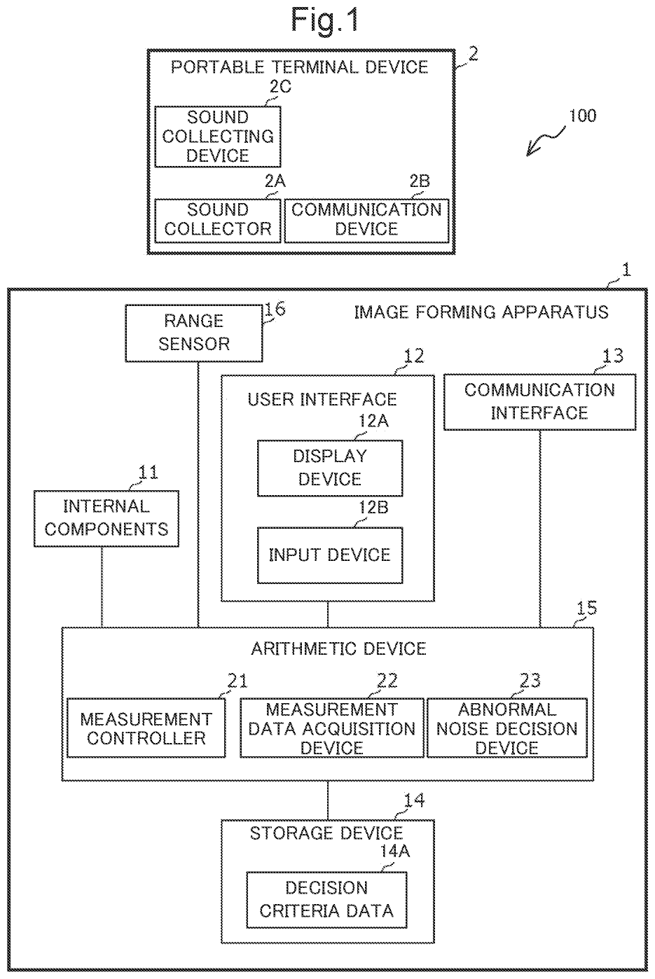

FIG. 1 is a block diagram showing a configuration of a device diagnosis system 100 according to a first embodiment of the disclosure. The device diagnosis system 100 shown in FIG. 1 includes an image forming apparatus 1, which is the subject to be diagnosed, and a portable terminal device 2 such as a smartphone.

The image forming apparatus 1 includes internal components 11 such as a printing device and an image reading device, which emit an operating sound, and also a user interface 12, a communication interface 13, a storage device 14, an arithmetic device 15, and a range sensor 16.

The user interface 12 includes a display device 12A (e.g., display panel) that displays various types of information to the user, and an input device 12B (e.g., keyboard, hard keys, and touch panel including soft keys) for receiving inputs by the user. The user interface 12 may be an external monitor connected to the image forming apparatus 1, or an external device (e.g., tablet PC) capable of communicating with the image forming apparatus 1.

The communication interface 13 is, for example, a peripheral device interface or a network interface, for communicating with an external device (e.g., portable terminal device 2). Here, the communication interface 13 includes a wireless communication interface (e.g., short-range wireless communication interface based on Bluetooth (registered trademark) protocol), for performing data communication with the portable terminal device 2.

The storage device 14 is a non-volatile storage device (e.g., hard disk drive or flash memory), containing therein various computer programs and various types of data. For example, decision criteria data 14A, acoustic data of the operating sound (e.g., waveform data, frequency distribution data) to be subsequently described, and diagnosis results are stored in the storage device 14. The decision criteria data 14A includes a plurality of decision criteria respectively corresponding to a plurality of sound collecting positions with respect to the image forming apparatus 1. Here, the decision criteria data 14A may be stored in an external storage device, instead of the storage device 14 incorporated in the image forming apparatus 1.

The plurality of sound collecting positions refer to the positions relative to the image forming apparatus 1, distant therefrom by one or a plurality of distances, in each of one or a plurality of directions (forward, backward, to the right side, to the left side, and so forth). The plurality of decision criteria are specified with respect to each of the plurality of sound collecting positions (i.e., direction from image forming apparatus 1 to each of the plurality of sound collecting positions, and the distance from the image forming apparatus 1 to each of the plurality of sound collecting positions).

The arithmetic device 15 is a computer including a central processing unit (CPU), a read-only memory (ROM), and a random-access memory (RAM), and acts as various types of processing units, by loading a computer program stored in the ROM or the storage device 14 on the RAM, and executing the same with the CPU. The range sensor 16 measures the distance from the image forming apparatus 1 to the portable terminal device 2.

In this embodiment, the arithmetic device 15 acts as a measurement controller 21, a measurement data acquisition device 22, and an abnormal noise decision device 23.

The measurement controller 21 controls the operation of the internal components 11, or sound collecting operation of the portable terminal device 2, in a predetermined sequence. For example, the measurement controller 21 makes connection to the portable terminal device 2 through the communication interface 13, and causes the portable terminal device 2 to execute a predetermined operation (e.g., collecting sounds).

The measurement data acquisition device 22 receives, through the communication interface 13, the acoustic data of the operating sound (e.g., waveform data, frequency distribution data) of the image forming apparatus 1, from the portable terminal device 2.

The abnormal noise decision device 23 (a) identifies the decision criterion corresponding to the sound collecting position selected by the user from the plurality of sound collecting positions, and (b) decides whether the operating sound of the image forming apparatus 1 contains an abnormal noise, on the basis of the acoustic data received from the portable terminal device 2, in accordance with the decision criterion identified as above.

To be more specific, the abnormal noise decision device 23 retrieves the decision criteria data 14A, and identifies the decision criterion corresponding to the sound collecting position that has been selected, on the basis of the decision criteria data 14A.

For example, the decision criterion refers to such an event that the volume level of the operating sound (maximum level or average level of the operating sound in a predetermined unit time) exceeds a predetermined threshold, or that a difference in volume level, between the operating sound in normal operation, acquired in advance, and the operating sound acquired at the current point, exceeds a predetermined threshold. Accordingly, for example the mentioned thresholds are specified as the decision criteria, in the decision criteria data 14.

The decision criterion is specified with respect to each of the plurality of sound collecting positions, since the volume level of the operating sound varies depending on the sound collecting position.

In the case where, for example, the image forming apparatus 1 includes a plurality of operating units, an operating sound proper to each of the operating unit is generated, depending on the structure of the operating unit. For example, when the image forming apparatus 1 includes, as the internal components 11, a printing device having a first sheet transport device for the printing sheets, and an image reading device having a second sheet transport device for source documents, the operating sound differs between the first sheet transport device of the printing device, and the second sheet transport device of the image reading device.

In addition, in the first sheet transport device of the printing device for example, the operating sound in a first operation mode in which the sheet is not transported, and the operating sound in a second operation mode in which the sheet is transported, are different from each other. Accordingly, a plurality of decision criteria may be specified with respect to each of a plurality of operation statuses of the image forming apparatus 1 (e.g., operating unit at work, operation mode being performed), and the decision criterion corresponding to the operation status of the image forming apparatus 1, designated in the diagnosis mode, may be identified, to thereby decide whether the operating sound of the image forming apparatus 1 contains an abnormal noise, in accordance with the decision criterion identified as above.

The portable terminal device 2 includes a sound collector 2A such as a microphone, a communication device 2B configured to communicate with the communication interface 13 of the image forming apparatus 1, and a sound collecting device 2C. The portable terminal device 2 includes a built-in computer, and acts as the sound collecting device 2C, when the computer executes a predetermined application.

The sound collecting device 2C collects the operating sound of the image forming apparatus 1, at the selected sound collecting position (i.e., when the portable terminal device 2 is located at that sound collecting position), and transmits the acoustic data of the collected operating sound to the image forming apparatus 1, through the communication device 2B.

In the first embodiment, the internal components 11 of the image forming apparatus 1 execute a specific operation, when the portable terminal device 2 is located by the user at the selected sound collecting position, and the sound collecting device 2C of the portable terminal device 2 collects the operating sound of the image forming apparatus 1 executing the specific operation, when the portable terminal device 1 is located by the user at the selected sound collecting position.

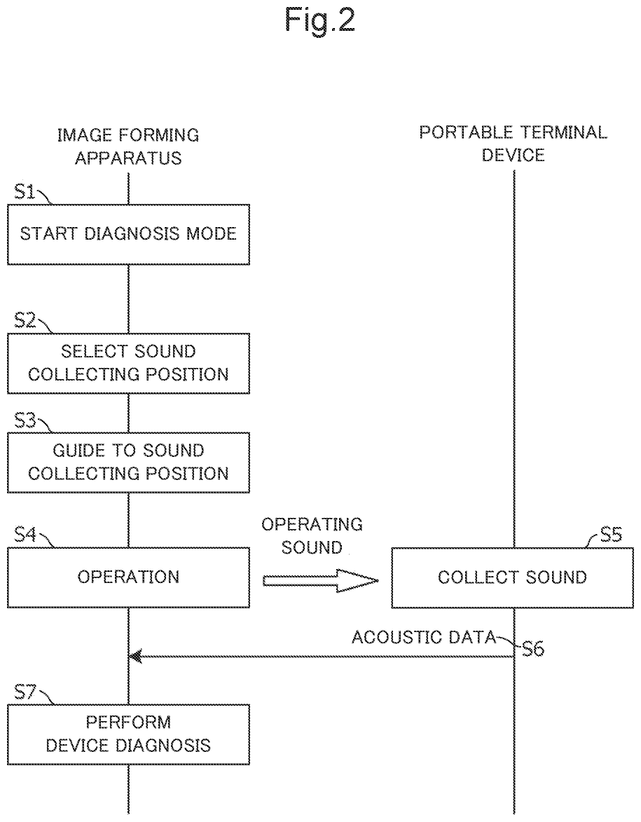

Hereunder, an operation of the device diagnosis system according to the first embodiment will be described. FIG. 2 is a sequence chart for explaining the operation of the device diagnosis system according to the first embodiment.

When the user performs a predetermined operation through the user interface 12 of the image forming apparatus 1, the following diagnosis mode is started (step S1).

When the diagnosis mode is started, the measurement controller 21 of the image forming apparatus 1 (a) displays a selection screen of the sound collecting position on the display device 12A, (b) detects the user's operation for selecting the sound collecting position, through the input device 12B such as the touch panel, and (c) selects the sound collecting position designated by the user's operation (step S2).

Then the measurement controller 21 displays a guide message on the display device 12A, or outputs an audible message from the speaker, to urge the user to locate the portable terminal device 2 at the selected sound collecting position (step S3). The guide message includes, for example, a text, an image, or a sound indicating the sound collecting position relative to the image forming apparatus 1 (direction and distance from the image forming apparatus 1). For example, when it is detected, through the input device 12B, that the user has located the portable terminal device 2 at the sound collecting position selected by the user, the measurement controller 21 decides that the portable terminal device 2 has been located at the selected sound collecting position.

At this point, the measurement controller 21 decides whether the portable terminal device 2 is located within a predetermined distance (e.g., 2 meters) from the image forming apparatus 1, using the range sensor 16 or the communication interface 13. In the case where the portable terminal device 2 is not located within the predetermined distance from the image forming apparatus 1, the measurement controller 21 displays a guide message on the display device 12A, or outputs an audible message from the speaker, to urge the user to locate the portable terminal device 2 within the predetermined distance from the image forming apparatus 1. The predetermined distance corresponds to a maximum distance, through which the portable terminal device 2 can collect the operating sound of the image forming apparatus 1.

For example, the communication device 2B and the communication interface 13 may perform data communication with each other, by the communication protocol of Bluetooth (registered trademark) Class 2, so that the measurement controller 21 may decide whether the portable terminal device 2 is located within the predetermined distance (in this case, within 2 meters through which the sound can be collected) from the image forming apparatus 1, on the basis of the intensity of the transmission wave of the communication device 2B, received by the communication interface 13. For reference, according to the communication protocol of Bluetooth (registered trademark) Class 2, the distance for the data communication is specified as within 6 meters.

Upon deciding that the portable terminal device 2 has been located at the selected sound collecting position, the measurement controller 21 transmits a sound collecting instruction to the portable terminal device 2, through the communication interface 13, and causes the internal components 11 to execute the specific operation (step S4).

On the part of the portable terminal device 2, the sound collecting device 2C collects, according to the sound collecting instruction, the operating sound of the image forming apparatus 1 through the sound collector 2A, for a predetermined period of time, generates the acoustic data of the collected operating sound (step S5), and then transmits the acoustic data to the image forming apparatus 1, through the communication device 2B (step S6).

In the mentioned process, the measurement controller 21 may output a specific sound indicating the start and the end of the operation, from the speaker. In this case, the starting timing and the ending timing of the operating sound in the acoustic data are indicated by the specific sound. Alternatively, only the specific sound indicating the start of the operation may be outputted from the speaker.

In the image forming apparatus 1, the measurement data acquisition device 22 receives the acoustic data through the communication interface 13. The abnormal noise decision device 23 looks up the decision criteria data 14A, to thereby identify the decision criterion corresponding to the selected sound collecting position, and decides whether the operating sound represented by the received acoustic data contains an abnormal noise, in accordance with the decision criterion identified as above (step S7). In this process, the abnormal noise decision device 23 may exclude the operating sound collected before the specific sound indicating the starting timing, and the operating sound collected after the specific sound indicating the ending timing, when deciding whether the operating sound contains an abnormal noise, in accordance with the identified decision criterion. Upon deciding that the operating sound contains an abnormal noise, the abnormal noise decision device 23 may identify the abnormal part corresponding to the abnormal noise, or the cause of the abnormality, and display the abnormal part or the cause of the abnormality on the display device 12A, or store the same in the storage device 14, as the diagnosis result.

Now, in the case of the aforementioned existing image forming apparatus, the timing that the abnormal noise has been generated is detected on the basis of a fixed threshold. Therefore, the timing that the abnormal noise has been generated may fail to be accurately detected, depending on a change in installation environment of the image forming apparatus (e.g., change in volume level of ambient noise).

In contrast, the device diagnosis system according to the first embodiment includes the image forming apparatus 1 to be diagnosed, the portable terminal device 2 that collects the operating sound of the image forming apparatus 1, and the abnormal noise decision device 23 that decides whether the collected operating sound contains an abnormal noise. The portable terminal device 2 collects the operating sound of the image forming apparatus 1, at a sound collecting position selected from the plurality of predetermined sound collecting positions relative to the image forming apparatus 1. The abnormal noise decision device 23 (a) identifies the decision criterion corresponding to the selected sound collecting position, and (b) decides whether the operating sound contains an abnormal noise, on the basis of the acoustic data of the operating sound collected, in accordance with the decision criterion identified.

With the mentioned configuration, the decision criterion is appropriately selected depending on the sound collecting position, and therefore the abnormal noise in the operating sound of the image forming apparatus 1 can be accurately detected.

### Second Embodiment

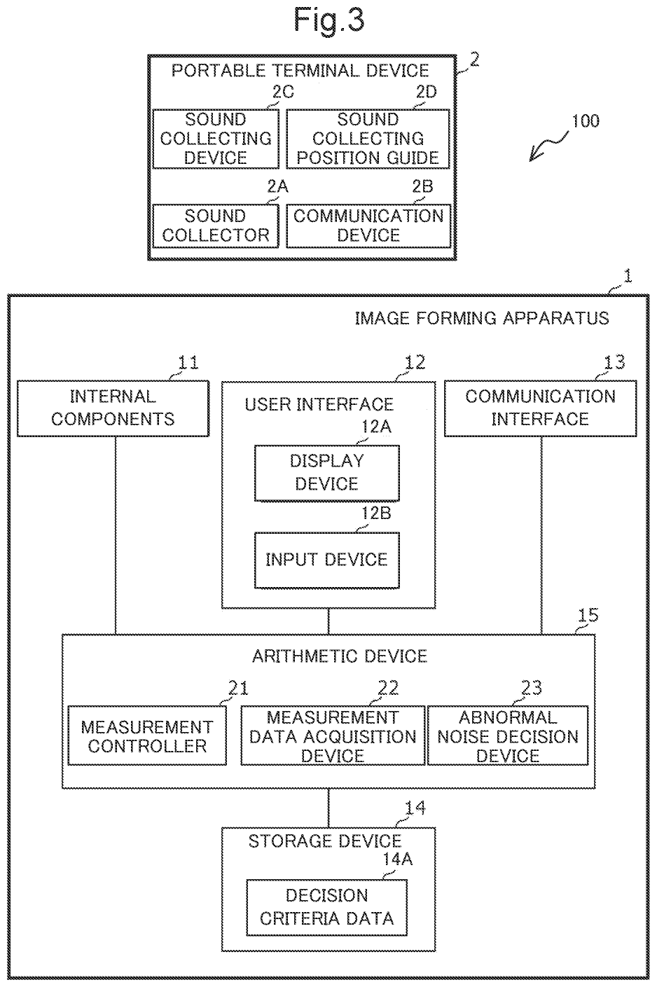

FIG. 3 is a block diagram showing a configuration of a device diagnosis system according to a second embodiment of the disclosure. In the second embodiment, as shown in FIG. 3, the image forming apparatus 1 is without the range sensor 16, and the portable terminal device 2 further includes a sound collecting position guide 2D.

The sound collecting position guide 2D (a) identifies, on the basis of the user's operation performed on the portable terminal device 2, the sound collecting position selected by the user from the plurality of predetermined sound collecting positions, and (b) guides the user so as to locate the portable terminal device 2 at the identified sound collecting position (i.e., sound collecting position selected by the user).

In the second embodiment, in addition, the measurement data acquisition device 22 receives the sound collecting position information together with the acoustic data, from the portable terminal device 2 through the communication interface 13. The sound collecting position information refers to the information indicating the identified sound collecting position (i.e., sound collecting position selected by the user).

Further, in the second embodiment, the abnormal noise decision device 23 (a) identifies the decision criterion corresponding to the sound collecting position information received (i.e., selected sound collecting position), and (b) decides whether the operating sound of the image forming apparatus 1 contains an abnormal noise, on the basis of the received acoustic data of the operating sound, in accordance with the decision criterion identified.

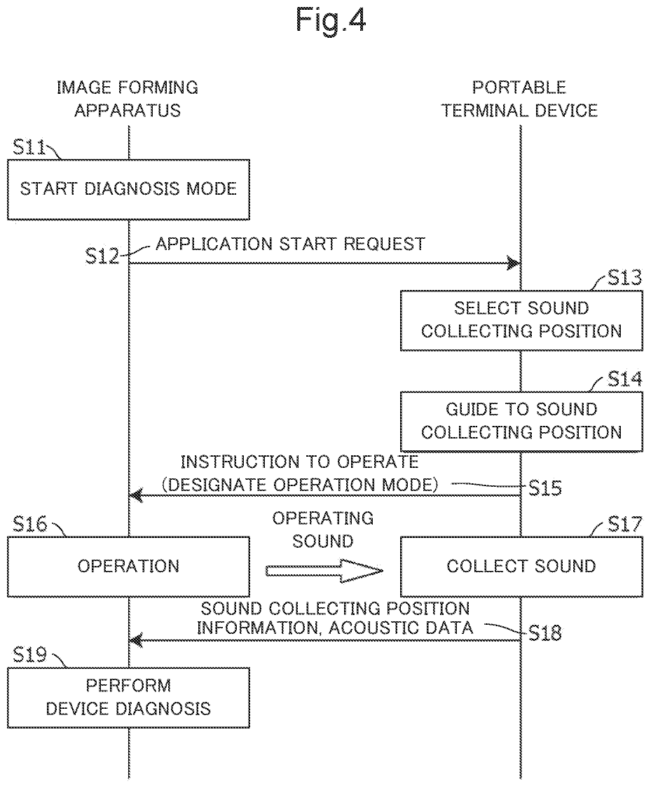

Hereunder, an operation of the device diagnosis system according to the second embodiment will be described. FIG. 4 is a sequence chart for explaining the operation of the device diagnosis system according to the second embodiment.

When the user performs a predetermined operation through the user interface 12 of the image forming apparatus 1, the following diagnosis mode is started (step S11).

When the diagnosis mode is started, the measurement controller 21 of the image forming apparatus 1 transmits an application start request to the portable terminal device 2, through the communication interface 13 (step S12). Upon receipt of the application start request through the communication device 2B, the portable terminal device 2 starts up the application designated by the application start request. Thus, the application involving the sound collecting device 2C and the sound collecting position guide 2D is started.

In the portable terminal device 2, the sound collecting position guide 2D (a) displays the selection screen of the sound collecting position, on a display panel of the portable terminal device 2, (b) detects the user's operation for selecting the sound collecting position, through an input device such as a touch panel, and (c) selects the sound collecting position designated by the user's operation (step S13).

Then the sound collecting position guide 2D displays the guide message urging the user to locate the portable terminal device 2 at the selected sound collecting position, on the display panel of the portable terminal device 2 (step S14). For example, upon detecting, through the input device of the portable terminal device 2, the user's operation indicating that the portable terminal device 2 has been located at the sound collecting position selected by the user, the sound collecting position guide 2D decides that the portable terminal device 2 has been located at the selected sound collecting position.

In this process, the sound collecting position guide 2D also decides, through the communication device 2B, whether the portable terminal device 2 is located within a predetermined distance (e.g., 2 meters) from the image forming apparatus 1. In the case where the portable terminal device 2 is not located within the predetermined distance from the image forming apparatus 1, the sound collecting position guide 2D displays a message urging the user to locate the portable terminal device 2 within the predetermined distance from the image forming apparatus 1, on the display panel of the portable terminal device 2. The predetermined distance may be specified similarly to the first embodiment.

When the portable terminal device 2 is located at the selected sound collecting position, the sound collecting device 2C transmits an instruction to execute a specific operation to the image forming apparatus 1, through the communication device 2B (step S15).

In the image forming apparatus 1, upon receipt of the instruction through the communication interface 13, the measurement controller 21 causes the internal components 11 to execute the specific operation designated by the instruction (step S16).

On the part of the portable terminal device 2, after transmitting the instruction, the sound collecting device 2C collects the operating sound of the image forming apparatus 1 through the sound collector 2A, for a predetermined period of time, and generates the acoustic data of the collected operating sound (step S17).

After collecting the operating sound, the sound collecting device 2C transmits the sound collecting position information indicating the selected sound collecting position, and the acoustic data of the operating sound, to the image forming apparatus 1 through the communication device 2B (step S18).

In the image forming apparatus 1, the measurement data acquisition device 22 receives the sound collecting position information and the acoustic data, through the communication interface 13, and the abnormal noise decision device 23 looks up the decision criteria data 14A, to thereby identify the decision criterion corresponding to the sound collecting position indicated by the sound collecting position information received, and decides whether the operating sound represented by the received acoustic data contains an abnormal noise, on the basis of the decision criterion identified (step S19).

As in the first embodiment, the measurement controller 21 may output a specific sound indicating the start of the operation, or the start and the end of the operation, from the speaker, and the abnormal noise decision device 23 may exclude a period defined by the specific sound in the acoustic data, when deciding whether the operating sound contains an abnormal noise. Further, upon deciding that the operating sound contains an abnormal noise, the abnormal noise decision device 23 may identify the abnormal part or the cause of the abnormality relevant to the abnormal noise, and display the abnormal part or the cause of the abnormality on the display device 12A, or store the same in the storage device 14, as the diagnosis result.

Other configurations and operations of the device diagnosis system according to the second embodiment are similar to those of the first embodiment. Therefore, description of such aspects will not be repeated.

### Third Embodiment

In a third embodiment, the portable terminal device 2 further includes a range sensor, and a ranging application for measuring a distance with the range sensor is installed. The sound collecting position guide 2D decides whether the portable terminal device 2 is located within the predetermined distance (e.g., 2 meters) from the image forming apparatus 1, using the ranging application, instead of using the communication device 2B as in the second embodiment. The ranging application may be automatically started by the sound collecting position guide 2D, or manually started by the user.

Further, the user may be allowed to select whether to use the communication device 2B as in the second embodiment (first decision mode), or use the ranging application (second decision mode), to decide whether the portable terminal device 2 is located within the predetermined distance from the image forming apparatus 1. In this case, the sound collecting position guide 2D selects either of the first decision mode and the second decision mode, according to the user's selection, and decides whether the portable terminal device 2 is located within the predetermined distance from the image forming apparatus 1, in the selected decision mode.

Other configurations and operations of the device diagnosis system according to the third embodiment are similar to those of the second embodiment. Therefore, description of such aspects will not be repeated.

### Fourth Embodiment

Although the measurement controller 21, the measurement data acquisition device 22, and the abnormal noise decision device 23 are incorporated inside the image forming apparatus 1, in the second embodiment, the mentioned components may be provided inside a device other than the image forming apparatus 1 (e.g., a server on the network).

Other configurations and operations of the device diagnosis system according to the fourth embodiment are similar to those of the second embodiment or the third embodiment. Therefore, description of such aspects will not be repeated.

Various modifications and alterations to the foregoing embodiments are obvious to those skilled in the art. Such modifications and alterations may be made without departing from the scope and spirit of the subject, and without compromising the intended advantages. In other words, such modifications and alterations are encompassed in the scope of the appended claims.

### INDUSTRIAL APPLICABILITY

The disclosure is applicable to detection and prediction of an abnormal part in an image forming apparatus.

What is claimed is:

1. A device diagnosis system comprising:
an image forming apparatus to be diagnosed;
a portable terminal device that collects an operating sound of the image forming apparatus, at a sound collecting position selected from a plurality of predetermined sound collecting positions relative to the image forming apparatus; and
an abnormal noise decision device including a processor, and configured to, when the processor executes a computer program:
(a) identify a decision criterion corresponding to the sound collecting position, and
(b) decide whether the operating sound contains an abnormal noise, on a basis of acoustic data of the operating sound collected, in accordance with the decision criterion identified.

2. The device diagnosis system according to claim 1, further comprising a storage device,
wherein the storage device contains decision criteria data indicating a plurality of decision criteria respectively corresponding to the plurality of sound collecting positions relative to the image forming apparatus, and
the abnormal noise decision device identifies the decision criterion corresponding to the sound collecting position, by looking up the decision criteria data.

3. The device diagnosis system according to claim 2,
wherein the plurality of decision criteria are specified with respect to a direction from the image forming apparatus to the respective sound collecting positions, and a distance from the image forming apparatus to the respective sound collecting positions.

4. The device diagnosis system according to claim 1,
wherein the image forming apparatus executes a specific operation, when the portable terminal device is located by a user at the sound collecting position selected, and
the portable terminal device collects the operating sound of the image forming apparatus executing the specific operation, when the portable terminal device is located by a user at the sound collecting position selected.

5. The device diagnosis system according to claim 4,
wherein the portable terminal device guides the user such that the portable terminal device is located by the user at the sound collecting position selected.

6. The device diagnosis system according to claim 1, further comprising:
one of a range sensor and a communication interface;
a display device; and
a measurement controller that decides, when the operating sound is collected, whether the portable terminal device is located within a predetermined distance, corresponding to a maximum distance through which the operating sound can be collected, using one of the range sensor and the communication interface, and causes the display device to display a message urging a user to locate the portable terminal device within the predetermined distance from the image forming apparatus, when the portable terminal device is not located within the predetermined distance.

7. A device diagnosis method for an image forming apparatus, to be performed using a portable terminal device, the device diagnosis method comprising:
a sound collecting process including collecting, with the portable terminal device, an operating sound of the image forming apparatus, at a sound collecting position selected from a plurality of predetermined sound collecting positions relative to the image forming apparatus; and
a decision process including (a) identifying a decision criterion corresponding to the sound collecting position, and (b) deciding whether the operating sound contains an abnormal noise, on a basis of acoustic data of the operating sound collected, in accordance with the decision criterion identified.
